(19) United States
(12) Patent Application Publication
(10) Pub. No.: US 2021/0135517 A1
(43) Pub. Date: May 6, 2021

(54) ROTOR FOR AN ELECTRIC MACHINE, ASSOCIATED PRODUCTION METHOD, AND ELECTRIC MACHINE FOR DRIVING A VEHICLE

(71) Applicant: VALEO SIEMENS EAUTOMOTIVE GERMANY GMBH, Erlangen (DE)

(72) Inventors: Wolfgang NEBE, Eggolsheim (DE); Bernhard KESSLER, Burkardroth (DE); Yves BURKHARDT, Erlangen (DE)

(21) Appl. No.: 17/082,170

(22) Filed: Oct. 28, 2020

(30) Foreign Application Priority Data
Oct. 30, 2019 (DE) 10 2019 129 243.3

(51) Int. Cl. H02K 1/27

(52) U.S. Cl. CPC H02K 1/2706

(57) ABSTRACT

A rotor for an electric machine, includes a laminated core which has magnet pockets extending in an axial direction, a plurality of first permanent magnet arrangements and a plurality of second permanent magnet arrangements. Each magnet arrangement includes a plurality of magnet elements arranged in the axial direction. The magnet arrangements are arranged one in each magnet pocket. The magnet elements of second magnet arrangements extend in each case along an axial transition portion in which opposite free ends of a pair of adjacent magnet elements of the first magnet arrangements are arranged.

The present invention relates to a rotor for an electric machine comprising a laminated core which has magnet pockets extending in an axial direction, a plurality of first permanent magnet arrangements and a plurality of second permanent magnet arrangements, each magnet arrangement comprising a plurality of magnet elements arranged in an axial direction, the magnet arrangements being arranged one in each magnet pocket.

The invention also relates to a method for producing a rotor and to an electric machine for driving a vehicle.

Such a rotor is known, for example, from the document EP 3 057 203 A1, which discloses a rotor of a permanently excited dynamoelectric rotary machine which has permanent magnets arranged in partially closed, substantially axially extending recesses. A number of permanent magnets are arranged axially side by side in the recesses.

If a resin is poured into the magnet pockets of such a rotor, a small amount of the resin penetrates between the individual laminations of the laminated core and thus joins the individual laminations of the laminated core together in integrally bonded fashion.

A disadvantage of such a rotor is that gaps may occur between the individual laminations because mechanical stresses may cause the resin that has entered between the individual laminations to crack. However, gaps may also occur in laminated cores that are assembled in other ways. Such gaps lead to an imbalance and may reduce the inherent frequencies of the rotor, which in turn leads to unwanted noise and vibrations during operation of the rotor or an electric machine formed therefrom. This is particularly undesirable in the field of vehicle drives.

The object of the invention is therefore to provide a mechanically robust rotor which may be operated in particular with low noise and low vibration.

According to the invention, in order to achieve this object, in a rotor of the aforementioned type, magnet elements of second magnet arrangements extend in each case along an axial transition portion in which opposite free ends of a pair of adjacent magnet elements of the first magnet arrangements are arranged.

The invention is based on the knowledge that gaps between individual laminations of the laminated core in conventional rotors typically occur in the transition areas when the free ends of adjacent magnet elements are at the same axial position in all magnet pockets. This considerably limits the stability of the laminated core at this point. The invention now provides for arranging the first and second magnet arrangements in such a way that the magnet elements of the first magnet arrangement on the one hand and of the second magnet arrangement on the other hand—in simple terms—overlap and thus stabilise the laminated core.

This effectively counteracts the undesirable phenomenon of gap formation in the laminated core, which considerably improves the mechanical robustness of the rotor. This also leads to a reduction of noise and vibrations during operation of the rotor, as unbalances caused by the gaps are effectively reduced or avoided. In addition, the inventive concept of overlapping without fundamental design changes may be implemented with little effort and at low cost in a variety of rotor topologies with permanent magnet arrangements, which have a number of magnet elements per magnet pocket.

It is preferred for the rotor according to the invention if the axial lengths of the magnet elements of a first magnet arrangement are the same. Thus, similar magnet elements may be used for the first magnet arrangements, as known from conventional rotors, for example.

The overlap mentioned at the outset may be realised, for example, in the rotor according to the invention in that the number of magnet elements of a first magnet arrangement and the number of magnet elements of a second magnet arrangement are different, preferably coprime.

Alternatively or additionally it may be provided in the rotor according to the invention that an axially outer magnet element of a second magnet arrangement arranged at one end of the laminated core has a different axial length than an axially outer magnet element of a first magnet arrangement arranged at the end face of the laminated core. In this way, an overlap of the axially outer magnet element may be realised. The axial length of the axially outer magnet element is not an integral multiple of the length of the axially outer magnet element of the second magnet arrangement at the end face.

According to an embodiment, it may be provided that the axial lengths of the other magnet elements of the second magnet arrangement are the same.

Alternatively, it may be provided that an axially outer magnet element of the second magnet arrangement arranged on the other end face of the laminated core has a different axial length than an axially outer magnet element of the first magnet arrangement arranged on this end face. In a refinement it may be provided that the axially outer magnet elements of the second magnet arrangement have the same axial length. It may also be provided that the magnet elements arranged between the axially outer magnet elements of the second magnet arrangement have the same axial length.

In the case of the rotor according to the invention, in specific embodiments it may be provided that the axial lengths of the magnet elements of a second magnet arrangement are the same. This is particularly advantageous if the axial lengths of the magnet elements of a first magnet arrangement are also the same and different from the axial length of the magnet elements of the second magnet arrangement. In this way, the principle according to the invention may be realised cost-effectively with a small variety of components.

A further possibility for realising the overlap, which may be provided as an alternative or in addition to the measures described above, is that each second magnet arrangement is offset by an axial distance from a first magnet arrangement. This measure makes use of the fact that laminated cores are often slightly longer axially than the magnet arrangements to compensate for manufacturing tolerances. There is thus an easily usable scope for generating an axial offset between the first magnet arrangements and the second magnet arrangements. It is preferable that the first magnet arrangement is flush with an axially outer single lamination having recesses for forming the magnet pockets.

In a refinement, it may be provided that the rotor further comprises spacers, which are arranged in the magnet pockets in which a second magnet arrangement is arranged and define the axial distance. The axially outer magnet element of the second magnet arrangement preferably touches the spacer. The spacer may be flush at an end face of the laminated core with a single lamination metal that has recesses for forming the magnet pockets. Preferably, the spacers are spherical or ellipsoidal or rounded bodies in order to avoid catching when inserted into the magnet pockets.

As will be explained in more detail below, it is particularly favourable in terms of production technology if the spacer is positioned between the second magnet arrangement and an end-face end element of the rotor through which the magnet pocket does not extend. The end element is preferably an end plate of the rotor or an end-face end lamination through which the magnet pockets do not extend.

In the rotor according to the invention, it has proved to be expedient from a construction viewpoint if a free end of a magnet element of the first magnet arrangement is spaced in the axial direction by at least three, preferably at least five, particularly preferably at least ten individual laminations of the laminated core from a free end of a magnet element of the second magnet arrangement. Alternatively or additionally it may be provided that a free end of a magnet element of the first magnet arrangement is spaced in the axial direction by at least 1 mm, preferably at least 1.5 mm, particularly preferably at least 3 mm from a free end of a magnet element of the second magnet arrangement.

In an electromagnetically advantageous embodiment of the rotor according to the invention, it is provided that the magnet pockets form a plurality of magnet pocket arrangements, each magnet pocket arrangement comprising a first magnet pocket and a second magnet pocket arranged in a radially outwardly open V-shape with respect to each other on both sides of a separation plane separating legs of the V-shape and extending in radial and axial directions.

The electromagnetic properties may be improved in particular by a so-called double V arrangement, which is characterised in that a magnet pocket arrangement further comprises a third magnet pocket and a fourth magnet pocket arranged in a radially outwardly open V-shape between both legs of the V-shape of the first magnet pocket and the second magnet pocket, the first magnet pocket and the third magnet pocket being arranged on one side of the separation plane and the second magnet pocket and the fourth magnet pocket being arranged on the other side of the separation plane.

With regard to the positions of the magnet arrangements, it may be provided, for example, that a first magnet arrangement is arranged in the third magnet pocket and a second magnet arrangement is arranged in the fourth magnet pocket, or that a second magnet arrangement is arranged in the third magnet pocket and a first magnet arrangement is arranged in the fourth magnet pocket.

In principle it may be provided that a first magnet arrangement is arranged in the first magnet pocket and a second magnet arrangement is arranged in the second magnet pocket, or that a second magnet arrangement is arranged in the first magnet pocket and a first magnet arrangement is arranged in the second magnet pocket.

According to an alternative embodiment, it is provided that a first magnet arrangement is arranged in the first magnet pocket and the second magnet pocket and a second magnet arrangement is arranged in the third magnet pocket and the fourth magnet pocket, or that a second magnet arrangement is arranged in the first magnet pocket and the second magnet pocket and a first magnet arrangement is arranged in the third magnet pocket and the fourth magnet pocket.

It is also within the scope of the invention if a magnet pocket arrangement comprises a further magnet pocket which preferably intersects the separation plane. Typically, the further magnet pocket is formed perpendicularly to a radius of the laminated core and/or perpendicularly to the separation plane. In combination with the V-shape, this is then also referred to as a delta shape or delta arrangement.

In principle, a first magnet arrangement or a second magnet arrangement may be arranged in the further magnet pocket. It is also possible that a first magnet arrangement is arranged in the further magnet pocket and a second magnet arrangement is arranged in the remaining magnet pockets of the magnet pocket arrangement, or that a second magnet arrangement is arranged in the further magnet pocket and a first magnet arrangement is arranged in the remaining magnet pockets of the magnet pocket arrangement.

Typically, a magnet pocket arrangement is provided in one of at least four sectors of the laminated core, which evenly divide the laminated core. The number of sectors may correspond to the number of rotor poles and in particular may be six, eight, ten or twelve.

The arrangement of the magnet arrangements is preferably the same in each magnet pocket arrangement. However, it may also be provided that first magnet pocket arrangements and second magnet pocket arrangements alternate with a different arrangement of the magnet arrangements in the circumferential direction as compared to the first magnet pocket arrangements. It is possible that only first magnet arrangements are arranged in the magnet pockets of the first magnet pocket arrangement and only second magnet arrangements are arranged in the magnet pockets of the second magnet pocket arrangement.

An advantage of the rotor according to the invention is further provided in that a joining means is arranged in a magnet pocket and, at least in part, surrounds the magnet arrangement arranged in the magnet pocket and/or extends between the individual laminations, the joining means joining adjacent individual laminations to each other and/or joining the magnet arrangement to the individual laminations in integrally bonded fashion and/or joining adjacent individual laminations to one another in integrally bonded fashion. The joining means is typically a resin.

The object underlying the invention is further achieved by a method for producing a rotor, in particular a rotor according to the invention, comprising the following steps: providing a laminated core having a plurality of magnet pockets extending in the axial direction; arranging magnet elements within the magnet pockets in the axial direction such that a plurality of permanent magnet arrangements are formed and such that magnet elements of second magnet arrangements extend in each case along an axial transition portion in which opposite free ends of a pair of adjacent magnet elements of the first magnet arrangements are arranged.

It may be provided that a spacer is arranged in the, or a, magnet pocket provided for receiving the second magnet arrangement and is supported at one end face of the laminated core to create an axial offset between the first and the second magnet arrangement.

In accordance with a further alternative refinement, it is provided that a tool is used to which the spacer is firmly connected, the tool sealing the magnet pockets at the end face. For example, the laminated core is arranged on the tool and filled with the magnet elements. For each magnet pocket for receiving a second magnet arrangement, the tool has a spacer which projects into the magnet pocket. After fixing the magnet elements to the laminated core, the tool together with spacer may be removed.

According to another alternative refinement, it is provided that the spacer is positioned on an end element of the rotor, through which end element no magnet pocket extends, with an end-face end lamination of the laminated core or an end plate arranged on the end face of the laminated core preferably being used as end element. In this case, for each magnet pocket for receiving a second magnet arrangement, a spacer may be inserted into the magnet pocket. The spacers typically remain in the rotor after a fixing operation.

It is further advantageous in the method according to the invention if it also comprises the following steps: introducing a joining means into the magnet pockets; and joining, in integrally bonded fashion, adjacent individual laminations to each other and/or a magnet arrangement to the individual laminations by the joining means. The introduction is preferably carried out by pouring. It is advisable to use a resin as the joining means. It is also preferred if the joining means is introduced before the magnet elements are arranged in the magnet pockets. This makes it easier for the magnet elements to be enclosed by the joining means and ensures good stability. It is also conceivable, however, that the magnet elements are arranged in the magnet pockets first and then the joining means is introduced.

Moreover, all statements made with regard to the rotor according to the invention may be transferred to the method according to the invention, so that the aforementioned advantages may also be achieved with this method. In particular, the magnet elements described in respect of the rotor may be used within the scope of the production method to form the first magnet arrangement or the second magnet arrangement.

The object underlying the invention is also achieved by an electric machine for driving a vehicle, comprising a rotor according to the invention or a rotor obtained by the method according to the invention. The rotor is mounted rotatably with respect to the stator.

Further advantages and details of the present invention shall become clear from the embodiments described below and in the drawings. These are schematic representations and show:

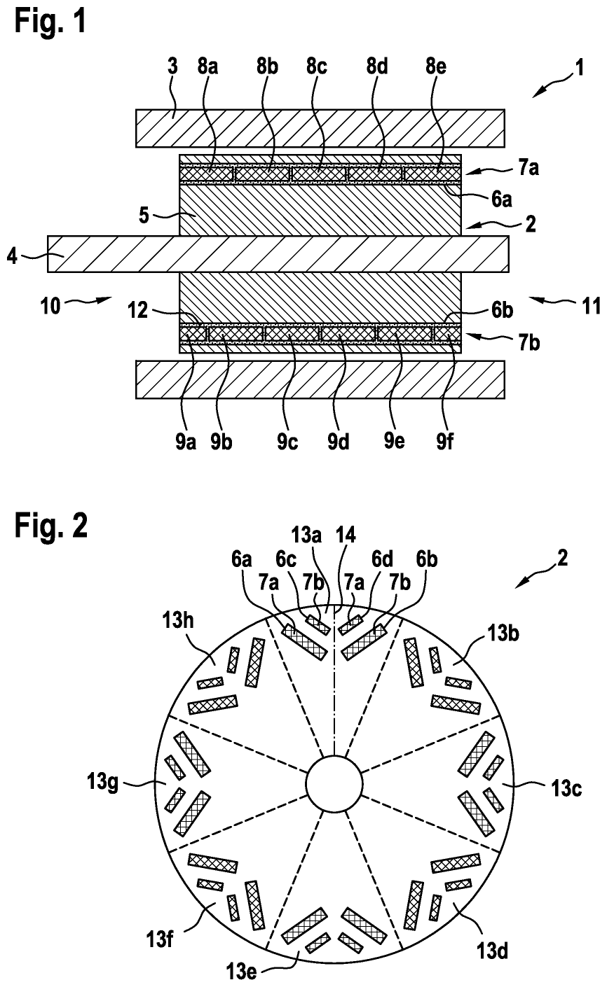

FIG. 1 a basic sketch of an embodiment of the electric machine according to the invention with a first embodiment of the rotor according to the invention;

FIG. 2A an end-face view of the rotor according to the first embodiment;

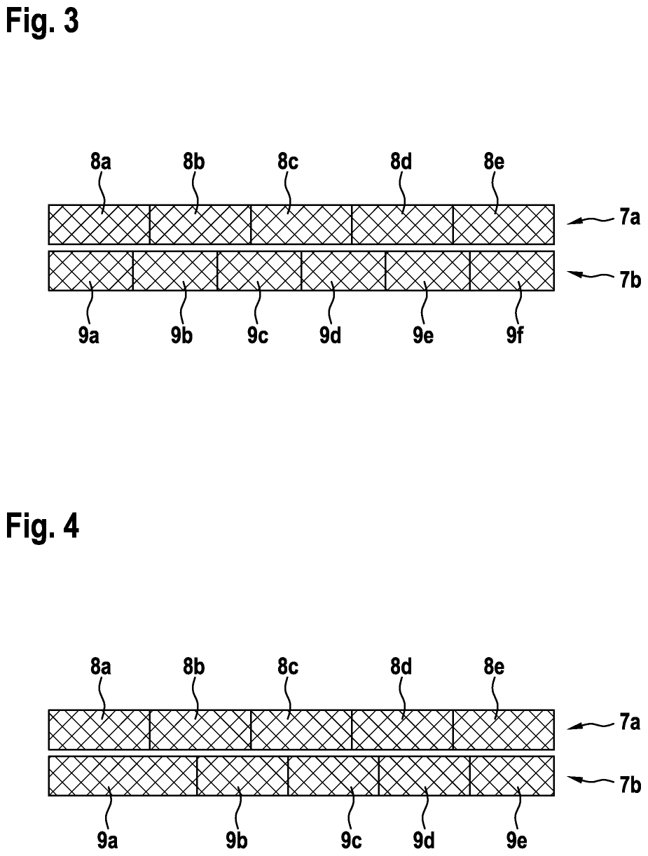

FIG. 3 a basic sketch of the arrangement of first and second magnet arrangements in a second embodiment of the rotor according to the invention;

FIG. 4 a basic sketch of the arrangement of first and second magnet arrangements in a third embodiment of the rotor according to the invention;

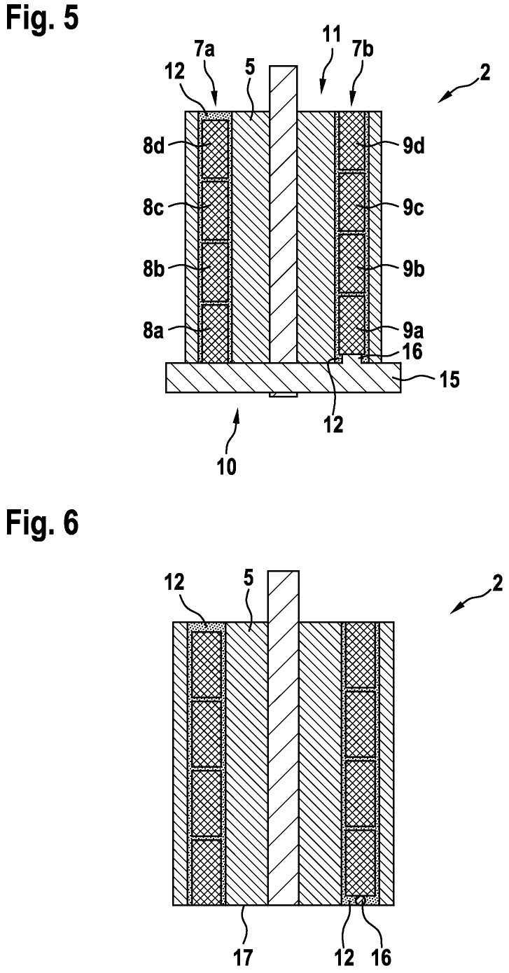

FIG. 5 a basic sketch of a fourth embodiment of the rotor according to the invention;

FIG. 6 a basic sketch of a fifth embodiment of the rotor according to the invention;

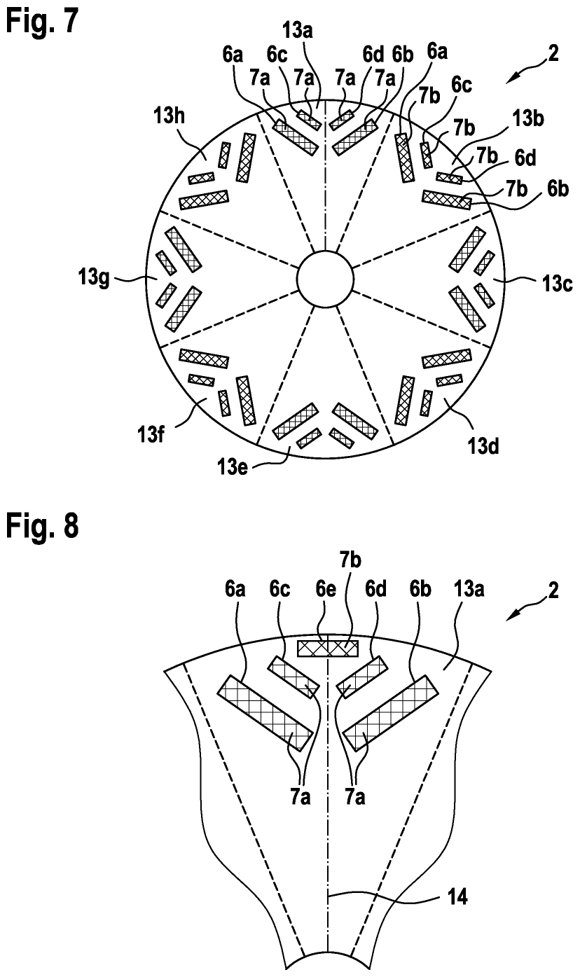

FIG. 7 an end-face view of a sixth embodiment of the rotor according to the invention; and

FIG. 8 an end-face view of a magnet pocket arrangement in a seventh embodiment of the rotor according to the invention.

FIG. 1 is a basic sketch of an embodiment of an electric machine 1 with a first embodiment of a rotor 2.

The electric machine 1 is a permanently excited synchronous machine and also has a stator 3 and a shaft 4. The rotor 2 is rotatably mounted inside the stator 3 and is connected to the shaft 4 for conjoint rotation by means of a press fit or a form fit.

The first embodiment of rotor 2 comprises a laminated core 5, which is formed from a multiplicity of axially layered individual laminations, which are not shown in greater detail for reasons of clarity. The laminated core 5 has a plurality of first magnet pockets 6a and second magnet pockets 6b extending in the axial direction as well as third magnet pockets 6c, 6d (see FIG. 2) not visible in FIG. 1, which are formed by congruently arranged recesses in the individual laminations.

Within each of the first magnet pockets 6a there is arranged a first permanent magnet arrangement 7a, and within each of the second magnet pockets 6b there is arranged a second permanent magnet arrangement 7b. The magnet arrangements 7a, 7b each comprise a plurality of magnet elements 8a-8e, 9a-9f, which are arranged in the axial direction within the corresponding magnet pocket 6a, 6b.

The magnet elements 8a-8e, 9a-9f are arranged in such a way that the magnet elements 9a-9f of the second magnet arrangements 7b extend in each case along an axial transition portion in which opposite free ends of a pair of adjacent magnet elements 8a-8e of the first magnet arrangement 7a are arranged. An overlap is thus realised between the magnet elements 8a-8e of the first magnet arrangement and the magnet elements 9a-9f of the second magnet arrangement 7b.

To create this overlap, axial lengths of the, for example five, magnet elements 8a8e of the first magnet arrangement 7a are equal. In the second magnet arrangement 7b, six magnet elements 9a-9f are provided by way of example. The axially outer magnet element 9a of the second magnet arrangement 7b arranged at one end face 10 of the laminated core 5 has a shorter axial length than the axially outer magnet element 8a of the first magnet arrangement 7a arranged at the end face 10. Likewise, the axially outer magnet element 9f of the second magnet arrangement 7b arranged at the other end face 11 of the laminated core 5 has a shorter axial length than the axially outer magnet element 8e of the first magnet arrangement 7a arranged at the end face 11. The axial lengths of the remaining magnet elements 9b-9e of the second magnet arrangement 7b have equal axial lengths corresponding to the axial length of a magnet element 8a-8e of the first magnet arrangement 7a.

From FIG. 1 it may also be seen that a joining means 12 in the form of a resin is arranged in a magnet pocket 6a-d and, at least in part, surrounds the magnet arrangement 7a, 7b arranged in the magnet pocket 6a-d and extends between the individual laminations. The joining means 12 joins both adjacent individual laminations to each other as well as the magnet arrangement 7a, 7b to the laminated core 5 and adjacent individual laminations to each other.

FIG. 2 is an end-face view of rotor 2.

The magnet pockets 6a-d form a number of similar magnet pocket arrangements 13a-13h, each of which is arranged in one of a number of sectors. The sectors subdivide the laminated core 5 evenly. The number of sectors corresponds to the number of rotor poles of the rotor 2, which in the present example is eight.

Each magnet pocket arrangement 13a-13h comprises one of the first magnet pockets 6a and one of the second magnet pockets 6b, which are arranged in a radially outwardly open V-shape with respect to each other on both sides of a separation plane 14 separating legs of the V-shape and extending in radial and axial directions. The magnet pockets 6a, 6b are arranged symmetrically with respect to the separation plane 14. In addition, each magnet pocket arrangement comprises one of the third magnet pockets 6c and one of the fourth magnet pockets 6d arranged in a radially outwardly open V-shape between both legs of the V-shape of the first and second magnet pockets 6a, 6b, the first magnet pocket 6a and the third magnet pocket 6c being arranged on one side of the separation plane 14 and the second magnet pocket 6b and the fourth magnet pocket 6d being arranged on the other side of the separation plane 14. A so-called “double V-arrangement” is thus realised.

In a magnet pocket arrangement 13a-13h, a first magnet arrangement 7a is arranged in the first magnet pocket 6a, a second magnet arrangement 7b in the second magnet pocket 6b, a second magnet arrangement 7b in the third magnet pocket 6c, and a first magnet arrangement 7a in the fourth magnet pocket 6d.

According to a further embodiment, a first magnet arrangement 7a is arranged in the first magnet pocket 6a and in the second magnet pocket 6b, and a second magnet arrangement 7b is arranged in the third magnet pocket 6c and in the fourth magnet pocket 6d.

According to a further embodiment, a second magnet arrangement 7b is arranged in the first magnet pocket 6a and in the second magnet pocket 6b, and a first magnet arrangement 7a is arranged in the third magnet pocket 6c and in the fourth magnet pocket 6d.

FIG. 3 is a basic sketch of the arrangement of the first and second magnet arrangement 7a, 7b in a second embodiment of a rotor 2, which otherwise corresponds to one of the embodiments described in conjunction with FIG. 1 and FIG. 2.

The second embodiment differs from the first embodiment in that the axial lengths of the magnet elements 9a-9f of the second magnet arrangement 7b are the same. However, in order to achieve the overlap, it must be ensured that the number of magnet elements 8a-e and the number of magnet elements 9a-9f are coprime.

FIG. 4 is a schematic diagram of the arrangement of the first and second magnet arrangement 7a, 7b in a third embodiment of a rotor 2, which otherwise corresponds to one of the embodiments described in conjunction with FIG. 1 and FIG. 2.

The third embodiment differs from the first embodiment in that the axially outer magnet element 9a has a greater axial length than the other magnet elements 9b9e, whose axial lengths are the same. This means that the overlap may also be achieved with the same number of magnet elements 8a-e on the one hand and magnet elements 9a-e on the other. Of course, according to another embodiment, it is also conceivable that the axially outer magnet element 9a has a smaller axial length than the other magnet elements 9b-9e.

FIG. 5 is a basic sketch of a fourth embodiment of a rotor 2. FIG. 5 also shows a tool 15, which is not part of the rotor 2 and will be explained later in conjunction with the production of the rotor 2.

In this embodiment, the first magnet arrangement 7a and the second magnet arrangement have the same number of magnet elements 8a-8d, 9a-9d, which in the present case is four, for example. All magnet elements 8a-8d, 9a-9d have the same axial length. The overlap is realised in this embodiment by offsetting a second magnet arrangement 7b by an axial distance relative to a first magnet arrangement 7a.

The axially outer magnet element 8a of the first magnet arrangement 7a, at the end face 10, is substantially flush with the axially outer individual lamination, which has a recess, whereas the laminated core 5 has a projection at the other end face 11 with respect to the other axially outer magnet element 8d. In the second magnet arrangement 7b, the axially outer magnet element 9d at the end face 11 is substantially flush with the axially outer individual lamination, which has a recess, whereas the laminated core 5 at the other end face 10 protrudes beyond the other axially outer magnet element 9a.

FIG. 6 is a basic sketch of a fifth embodiment of a rotor 2, which corresponds to the fourth embodiment except for the deviations described below.

In this embodiment, the second magnet arrangement 7b is offset relative to the first magnet arrangement 7a by a spacer 16 arranged in a magnet pocket in which one of the second magnet arrangements 7b is received. The spacer 16 is also surrounded at least in part by the joining means 12.

A spacer 16 is arranged between the second magnet arrangement and an end-face end element 17 of the rotor 2, through which end element the magnet pockets do not extend, in the form of an end plate fitted at the end face on the laminated core 5. According to a further embodiment, the end element 17 is an end-face end lamination of the laminated core 5.

FIG. 7 is an end-face view of a sixth embodiment of a rotor 2.

In the sixth embodiment, a first magnet arrangement 7a is arranged in each of the magnet pockets 6a-6d of first magnet pocket arrangements 13a, 13c, 13e, 13g and a second magnet arrangement 7b is arranged in each of the magnet pockets 6a-6d of second magnet pocket arrangements 13b, 13d, 13f, 13h. The first and second magnet pocket arrangements 13a-13h alternate in the circumferential direction. Otherwise, the sixth embodiment may correspond to one of the previously described embodiments.

FIG. 8 is an end-face view of a magnet pocket arrangement 13a of a seventh embodiment of a rotor 2.

In the seventh embodiment, each magnet pocket arrangement 13a-h additionally has a further magnet pocket 6e, which lies perpendicularly on the separation plane 14 and forms a delta arrangement with the first magnet pocket 6a and the second magnet pocket 6b. The third and fourth magnet pockets 6c, 6d are optional in this case. In so far as the distribution of the first and second magnet arrangements 7a, 7b over the first to fourth magnet pockets 6a-6d corresponds to one of the previously described embodiments, a first magnet arrangement 7a or a second magnet arrangement 7b in principle may be arranged in the further magnet pocket 6e as desired.

However, it is also possible that in all magnet pocket arrangements 13a-h—as shown in FIG. 8—a first magnet arrangement 7a is arranged in the first to fourth magnet pockets 6a-6d and a second magnet arrangement 7b is arranged in the further magnet pocket 6e. According to an alternative embodiment, all magnet pocket arrangements 13a-h have a second magnet arrangement 7a arranged in the first to fourth magnet pockets 6a-6d and a first magnet arrangement 7b arranged in the further magnet pocket 6e.

A first embodiment of a method for producing a rotor 2 according to FIG. 1 to FIG. 4 will be described hereinafter.

In a first step, a laminated core 5 with a plurality of magnet pockets 6a-6d extending in the axial direction is provided.

In a further step, the laminated core 5 is arranged with one of the end faces 10, 11 on a tool which seals the magnet pockets 6a-d axially and radially.

In a further step, a resin is poured as joining means 12 into the magnet pockets 6a-6d.

In a further step, magnet elements 8a-8e, 9a-9e are arranged within the magnet pockets 6a-6d in the axial direction in such a way that a plurality of permanent magnet arrangements 7a, 7b are formed and the magnet elements 9a-9e of the second magnet arrangements 7b extend in each case along an axial transition portion in which opposite free ends of a pair of adjacent magnet elements 8a-8e of the first magnet arrangements 7a are arranged. The axially outer magnet elements 8a, 9a or the axially outer magnet elements 8e, 9e or 9f rest on the tool.

In a further step, adjacent individual laminations are joined together and the magnet arrangements 7a, 7b are joined to the individual laminations in integrally bonded fashion by the joining means 12.

In a further step the tool is removed.

As an alternative to using the tool, an end element 17 may be used as shown in FIG. 6, through which end element no magnet pockets 6a-6d extend and which seals the magnet pockets 6a-6d axially and radially. For this purpose, the lam inated core 5 may be provided with an end lamination in the first step, or an end plate may be provided additionally, which is arranged at the end face of the laminated core 5.

A second embodiment of a method for producing a rotor 2 according to FIG. 5 will be described hereinafter.

In a first step, a laminated core 5 with a plurality of magnet pockets extending in the axial direction is provided.

In a further step, the laminated core 5 with one of the end faces 10, 11 is arranged on a tool which seals the magnet pockets axially and radially.

In a further step, a resin is poured as a joining means 12 into the magnet pockets.

In a further step, magnet elements 8a-8e, 9a-9e are arranged within the magnet pockets in the axial direction in such a way that a plurality of permanent magnet arrangements 7a, 7b are formed and the magnet elements 9a-9d of the second magnet arrangements 7b extend in each case along an axial transition portion in which opposite free ends of a pair of adjacent magnet elements 8a-8d of the first magnet arrangements 7a are arranged. The axially outer magnet elements 8a, 9a or the axially outer magnet elements 8e, 9e or 9f rest on the tool 15. For each magnet pocket for receiving a second magnet arrangement, the tool 15 has a spacer 16 which projects into the magnet pocket.

In a further step, adjacent individual laminations are joined to each other and the magnet arrangements 7a, 7b are joined to the individual laminations in integrally bonded fashion by the joining means 12.

In a further step the tool 15 together with the spacer 16 is removed.

A third embodiment of a method for producing a rotor 2 according to FIG. 6 will be described hereinafter.

In a first step, a laminated core 5 having a plurality of magnet pockets extending in the axial direction is provided, the laminated core 5 having an end element 17, through which no magnet pockets extend and which seals the magnet pockets axially and radially, in the form of an end lamination. Alternatively, an end plate is also provided as an end element 17 and is arranged at the end face of the laminated core 5.

In a further step, a resin is poured as a joining means 12 into the magnet pockets.

In a further step, a spacer 16 in the form of a spherical, ellipsoidal or otherwise rounded body is arranged in such magnet pockets, which are intended to receive a second magnet arrangement 7b. Alternatively, the spacer 16 may be placed in position before the joining means 12 is introduced.

In a further step, magnet elements 8a-8e, 9a-9e are arranged within the magnet pockets in the axial direction in such a way that a plurality of permanent magnet arrangements 7a, 7b are formed and the magnet elements 9a-9d of the second magnet arrangements 7b extend in each case along an axial transition portion in which opposite free ends of a pair of adjacent magnet elements 8a-8d of the first magnet arrangements 7a are arranged.

In a further step, adjacent individual laminations are joined to each other and the magnet arrangements 7a, 7b are joined to the individual laminations in integrally bonded fashion by the joining means 12.

According to further embodiments of the production method, which otherwise correspond to one of the previously described embodiments, the magnet elements may be placed in position before the joining means 12 is introduced.

1. A rotor (2) for an electric machine (1), comprising a laminated core (5) which has magnet pockets (6a-6e) extending in an axial direction, a plurality of first permanent magnet arrangements (7a) and a plurality of second permanent magnet arrangements (7b), each magnet arrangement (7a, 7b) comprising a plurality of magnet elements (8a-8e, 9a-9f) arranged in the axial direction, the magnet arrangements (7a, 7e) being arranged one in each magnet pocket (6a-6e),
wherein
magnet elements (9a-9f) of second magnet arrangements (7b) extend in each case along an axial transition portion in which opposite free ends of a pair of adjacent magnet elements (8a-8e) of the first magnet arrangements (7a) are arranged.

2. The rotor according to claim 1, wherein
the axial lengths of the magnet elements (8a-8e) of a first magnet arrangement (7a) are equal and/or
the number of magnet elements (8a-8e) of a first magnet arrangement (7a) and the number of magnet elements (9a-9f) of a second magnet arrangement (7b) are different, preferably coprime.

3. The rotor according to claim 1, wherein
an axially outer magnet element (9a) of a second magnet arrangement (7b) arranged at an end face (10) of the laminated core (5) has a different axial length than an axially outer magnet element (8a) of a first magnet arrangement (7a) arranged at the end face (10) of the laminated core (5).

4. The rotor according to claim 3, wherein
the axial lengths of the remaining magnet elements (9b-9e) of the second magnet arrangement (7a) are equal.

5. The rotor according to claim 3, wherein
an axially outer magnet element (9f) of the second magnet arrangement (7b) arranged on the other end face (11) of the laminated core (5) has a different axial length than an axially outer magnet element (8e) of the first magnet arrangement (7a) arranged at this end face (11), wherein it is preferably provided that the axially outer magnet elements (9a, 9f) of the second magnet arrangement (7b) have the same axial length and/or that the magnet elements (9b-9e) arranged between the axially outer magnet elements (9a, 9f) of the second magnet arrangement (7b) have the same axial length.

6. The rotor according to one of claim 1, wherein the axial lengths of the magnet elements (9a-9f) of a second magnet arrangement (7b) are the same.

7. The rotor according to claim 1, wherein
each second magnet arrangement (7b) is offset by an axial distance relative to a first magnet arrangement (7a).

8. The rotor according to claim 7, which
further comprises spacers (16), which are arranged in the magnet pockets in which a second magnet arrangement (7b) is arranged and define the axial distance.

9. The rotor according to claim 8, wherein
a spacer (16) is arranged between the second magnet arrangement and an end-face end element (17) of the rotor (2), preferably an end plate of the rotor (2) or an end-face end lamination, through which the magnet pocket does not extend, of the laminated core (5).

10. The rotor according to claim 1, wherein
the magnet pockets (6a-6e) form a plurality of magnet pocket arrangements (13a-13h), wherein each magnet pocket arrangement (13a-13h) comprises a first magnet pocket (6a) and a second magnet pocket (6b) arranged in a radially outwardly open V-shape with respect to each other on both sides of a separation plane (14) separating legs of the V-shape and extending in radial and axial directions.

11. The rotor according to claim 10, wherein
a magnet pocket arrangement (13a-13h) further comprises a third magnet pocket (6c) and a fourth magnet pocket (6d) arranged in a radially outwardly open V-shape between both legs of the V-shape of the first magnet pocket (6a) and second magnet pocket (6b), wherein the first magnet pocket (6a) and the third magnet pocket (6c) are arranged on one side of the separation plane (14) and the second magnet pocket (6b) and the fourth magnet pocket (6d) are arranged on the other side of the separation plane (14).

12. The rotor according to claim 11, wherein
a first magnet arrangement (7a) is arranged in the third magnet pocket (6c) and a second magnet arrangement (7b) is arranged in the fourth magnet pocket (6d) or
a second magnet arrangement (7b) is arranged in the third magnet pocket (6c) and a first magnet arrangement (7a) is arranged in the fourth magnet pocket (6d).

13. The rotor according to claim 11, wherein
a first magnet arrangement (7a) is arranged in the first magnet pocket (6a) and the second magnet pocket (6b) and a second magnet arrangement (7b) is arranged in the third magnet pocket (6c) and the fourth magnet pocket (6d), or
a second magnet arrangement (7b) is arranged in the first magnet pocket (6a) and the second magnet pocket (6b) and a first magnet arrangement (7a) is arranged in the third magnet pocket (6c) and the fourth magnet pocket (6d).

14. The rotor according to claim 10, wherein
a first magnet arrangement (7a) is arranged in the first magnet pocket (6a) and a second magnet arrangement (7a) is arranged in the second magnet pocket (6b) or
a second magnet arrangement (7b) is arranged in the first magnet pocket (6a) and a first magnet arrangement (7a) is arranged in the second magnet pocket (6b).

15. The rotor according to claim 1, wherein
a joining means (12) is arranged in a magnet pocket (6a-6e) and surrounds, at least in part, the magnet arrangement (7a, 7b) arranged in the magnet pocket (6a-6e) and/or extends between individual laminations of the laminated core (5), wherein the joining means (12) joins adjacent individual laminations to each other and/or the magnet arrangement (7a, 7b) to the individual laminations in integrally bonded fashion and/or joins adjacent individual laminations to each other in integrally bonded fashion.

16. A method for producing a rotor (2), in particular a rotor (2) according to claim 1, comprising the following steps:
providing a laminated core (5) having a plurality of magnet pockets (6a-6e) extending in the axial direction;
arranging magnet elements (8a-8e, 9a-9f) within the magnet pockets (6a-6e) in the axial direction in such a way that a plurality of permanent magnet arrangements (7a, 7b) are formed and magnet elements (9a-9f) of second magnet arrangements (7b) extend in each case along an axial transition portion in which opposite free ends of a pair of adjacent magnet elements (8a-8e) of the first magnet arrangements (7a) are arranged.

17. The method according to claim 16, wherein
a spacer (16) is arranged in a magnet pocket intended for receiving a second magnet arrangement (7b) and is supported at an end face of the laminated core (5) to create an axial offset between the first and second magnet arrangements (7a, 7b).

18. The method according to claim 17, wherein
a tool (15) is used, to which the spacer (16) is firmly connected, wherein the tool (15) seals the magnet pockets (6a-6e) at the end faces, or
the spacer (16) is positioned on an end element (17) of the rotor (2), through which end element no magnet pocket (6a-6e) extends, wherein preferably an end-face end lamination of the laminated core (5) or an end plate arranged at the end face on the laminated core (5) is used as end element (17).

19. The method according to claim 16, further comprising the following step:
joining adjacent individual laminations to each other and/or a magnet arrangement (7a, 7b) to the individual laminations in integrally bonded fashion by introducing, preferably pouring, a joining means (12), preferably a resin, into a magnet pocket (6a-6e), preferably before arranging the magnet elements (8a-8e, 9a-9f) in the magnet pockets (6a-6e).

20. An electric machine (1) for driving a vehicle, comprising a stator (3) and
a rotor (2) comprising a laminated core (5) which has magnet pockets (6a-6e) extending in an axial direction, a plurality of first permanent magnet arrangements (7a) and a plurality of second permanent magnet arrangements (7b), each magnet arrangement (7a, 7b) comprising a plurality of magnet elements (8a8e, 9a-9f) arranged in the axial direction, the magnet arrangements (7a, 7e) being arranged one in each magnet pocket (6a-6e),
wherein magnet elements (9a-9f) of second magnet arrangements (7b) extend in each case along an axial transition portion in which opposite free ends of a pair of adjacent magnet elements (8a-8e) of the first magnet arrangements (7a) are arranged, or
a rotor (2) obtained by a method according to claim 16, wherein the rotor (2) is mounted rotatably with respect to the stator (3).
